(19) United States
(12) Patent Application Publication
(10) Pub. No.: US 2007/0292157 A1
(43) Pub. Date: Dec. 20, 2007

(54) Image Forming System, Image Forming Apparatus And Controlling Device For The Image Forming Apparatus

(75) Inventor: Junji Sato, Tokyo (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/745,367

(22) Filed: May 7, 2007

(30) Foreign Application Priority Data
Jun. 20, 2006 (JP) 2006-170499

(51) Int. Cl. G03G 15/00

(52) U.S. Cl. 399/82

(57) ABSTRACT

An image forming system is provided with a setting inputting section to set a tandem mode and a control section. When the tandem mode is set by the setting inputting section, the control section assigns an image formation from a leading page to a first page in a predetermined page range of the single image formation job to first image forming apparatus and assigns an image formation from a next page of the first page to a trailing page in the predetermined page range to second image forming apparatus, and the first image forming apparatus executes the image formation in an ascending order of pages with a group output to output a designated number of sets for each page and the second image forming apparatus executes the image formation from in a descending order of pages with the group output.

### CROSS-REFERENCE TO RELATED APPLICATION

This application is based on Japanese Patent Application No. 2006-170499 filed on Jun. 6, 2006, in Japanese Patent Office, the entire content of which is hereby incorporated by reference.

### BACKGROUND OF THE INVENTION

The present invention relates to an image forming system that allows a group output in which each number of copies are outputted in the ascending order or the descending order of pages, in a tandem mode that outputs by allocating one JOB by plural image forming apparatuses, an image forming apparatus and a control device for the image forming apparatus.

With a tendency of digitization and networking of an image forming apparatus such as a copying machine, a printer or a hybrid machine, backed by evolution of advanced computerization technology in recent years, a technology of tandem output system (tandem mode) wherein a plurality of image forming apparatuses are connected, and document images read by a single image reading device are copied at high speed by plural image forming apparatuses, and image data sent from a computer are outputted at high speed by plural printers, and thereby, a large number of sheets of images are obtained in a short time. In this tandem output, printing at high speed in a short period of time is usually possible, by allocating prescribed number of prints to respective image forming apparatuses in the order of pages sorted (sort sheet ejection mode). In addition to the aforesaid sort mode, some of the image forming apparatuses are provided with a group output mode to conduct printing in the ascending or descending page order (FIG. 10 shows ascending page order) as shown in FIG. 10 (a), and it is desired that an output by this group output mode is made to be possible even in the aforesaid tandem mode. For this desire, for example, it is considered to conduct group output by a tandem mode, by dividing output pages range into two parts as shown in FIG. 10 (b), and by outputting the first half with a single image forming apparatus and by outputting the second half with another image forming apparatus. Further, there has been suggested an image forming method to assign pages to respective image forming apparatuses in the prescribe order (Japanese Patent Publication Open to Public Inspection No. 08-249452)

Incidentally, in the conventional tandem mode, when allocating, the number of copies to be outputted are evenly allocated to respective image forming apparatuses, or the number of copies to be outputted are allocated to respective image forming apparatuses depending on output capacity of each image forming apparatus. However, even in the case where the number of copies to be outputted is allocated in consideration of output capacity of each image forming apparatus as stated above, a difference of the progress of output is sometimes generated between respective image forming apparatuses, by working conditions such as sheet running out and sheet jamming or by waiting for output of another reserved job, which is natural in the case where the number of copies to be outputted are evenly allocated to respective image forming apparatuses each having a different capacity of outputting.

Therefore, there has been proposed an image forming apparatus having an allocation recovery function to quicken the processing in the total image forming apparatuses wherein, when output is completed earlier by a partial image forming apparatus than other image forming apparatuses, the allocation is changed by transferring a part of unfinished copies among those allocated to image forming apparatuses which are working to the image forming apparatus which has finished its share, and the image forming apparatus which has finished its share earlier outputs the transferred unfinished copies, in place of other image forming apparatuses.

This allocation recovery function can be carried out easily, because the number of copies in other image forming apparatuses are only undertaken, in the tandem output in the sort sheet ejection mode in which the prescribed number of copies is allocated. However, in the case of conducting tandem output under the group output mode, by dividing a range of pages to be outputted only, and by allocating to each image forming apparatus for each page as stated above, when a partial image forming apparatus has finished output of its share, that partial image forming apparatus cannot output by regulating an order of output, even when it undertakes the allocations of other image forming apparatuses, and rearrangement of outputted ones by user's handwork is needed, thus, efficiency of processing cannot be improved sufficiently, which is a problem.

### SUMMARY OF THE INVENTION

The present invention has been achieved in view of the aforesaid background, and its objective is to provide an image forming system, an image forming apparatus and a control device for the image forming apparatus wherein group output can be carried out in tandem output and allocation recovery to change allocation based on the state of progress of output of each image forming apparatus can easily be practiced.

The above object can be attained by the following structures which are reflected with one aspect of the invention.

An image forming system in which plural image forming apparatuses to form an image on a recording medium based on image data are connected to be able to communicate, is provided with:

a setting inputting section to set a tandem mode to execute a single image formation job by sharing the job among plural image forming apparatuses; and

a control section to control first and second image forming apparatuses such that when the tandem mode is set by the setting inputting section, the control section assigns an image formation from a leading page to a first page in a predetermined page range of the single image formation job to the first image forming apparatus and assigns an image formation from a next page of the first page to a trailing page in the predetermined page range to the second image forming apparatus, and the first image forming apparatus executes the image formation from the leading page to the first page in an ascending order of pages with a group output to output a designated number of sets for each page and the second image forming apparatus executes the image formation from the next page of the first page to the trailing page in a descending order of pages with a group output to output a designated number of sets for each page.

An image forming apparatus, is provided with:

an image forming section to form an image on an image recording medium based on image data;

a communicating section to connect to be able to communicate with other image forming apparatus;

a setting inputting section to set a tandem mode to execute a single image formation job by sharing the job with the other image forming apparatus; and

a control section to control the image forming section and to output an instruction to the other image forming apparatus through the communicating section such that when the tandem mode is set by the setting inputting section, the control section assigns an image formation from a leading page to a first page in a predetermined page range of the single image formation job to one of the image forming apparatus and the other image forming apparatus and assigns an image formation from a next page of the first page to a trailing page in the predetermined page range to the other one of the image forming apparatus and the other image forming apparatus, the one of the image forming apparatus and the other image forming apparatus executes the image formation from the leading page to the first page in an ascending order of pages with a group output to output a designated number of sets for each page and the other one of the image forming apparatus and the other image forming apparatus executes the image formation from the next page of the first page to the trailing page in a descending order of pages with a group output to output sets of the designated number for each page.

A control device, is provided with;

a setting inputting section to set a tandem mode to execute a single image formation job by sharing the job among plural image forming apparatuses to form an image on a recording medium based on image data; and

a control section to control first and second image forming apparatuses among the plural image forming apparatuses such that:

when the tandem mode is set by the setting inputting section, the control section assigns an image formation from a leading page to a first page in a predetermined page range of the single image formation job to the first image forming apparatus and assigns an image formation from a next page of the first page to a trailing page in the predetermined page range to the second image forming apparatus, and

the control section instructs based on the assignment such that the first image forming apparatus executes the image formation from the leading page to the first page in an ascending order of pages with a group output to output a designated number of sets for each page and the second image forming apparatus executes the image formation from the next page of the first page to the trailing page in a descending order of pages with a group output to output a designated number of sets for each page.

### BRIEF DESCRIPTION OF THE DRAWINGS

FIG. 1 is a schematic diagram showing the mechanical structure of an image forming apparatus in the embodiment of the invention.

FIG. 2 is a network connection diagram including a functional block diagram in the aforesaid embodiment of the invention.

FIG. 3 is a schematic diagram showing the main operation screen in the aforesaid embodiment of the invention.

FIG. 4 is a schematic diagram showing the output setting screen in the aforesaid embodiment of the invention.

FIG. 5 is a flow chart showing the setting procedure in a tandem group output in the aforesaid embodiment of the invention.

FIG. 6 shows a schematic diagram showing a tray ejection image in the sheet ejection order in the tandem group, and a schematic diagram showing a tray ejection image in the sheet ejection direction, in the aforesaid embodiment of the invention.

FIG. 7 is a flow chart showing the procedure of allocation recovery in the aforesaid embodiment of the invention.

FIG. 8 is a network connection diagram including a functional block diagram in another embodiment of the invention.

FIG. 9 is a flow chart showing the procedure of the tandem group output in the aforesaid embodiment of the invention.

FIG. 10 shows a schematic diagram (a) showing a tray ejection image in the group output mode.

### DETAILED DESCRIPTION OF THE PREFERRED EMBODIMENT

Hereinafter, embodiments of the present invention are explained, however, the present invention is not limited to the embodiments.

Firstly, preferable structures to attain the above object are explained.

Namely, in the image forming system of the present invention, the image forming system described in Item 1 is an image forming system capable of executing a tandem mode to conduct an image formation with regard to a single image formation job by sharing it with plural image forming apparatuses to form an image on an image recording medium based on image data, the image forming system is characterized by comprising:

an instruction inputting section to input an instruction to set a execution of the tandem mode; and

a control section to control at least two image forming apparatuses such that when an instruction to set executing the tandem mode by is inputted by the instruction inputting section, the control section assigns an execution of an image formation from a leading page to a first page in a predetermined page range of the single image formation job to one of the two image forming apparatuses and assigns an execution of an image formation from a next page of the first page to a trailing page in the predetermined page range to the other one of the two image forming apparatuses, the one of the two image forming apparatuses executes the image formation from the leading page to the first page in an ascending order of pages with a group output to output a designated number of sets for each page and the other one of the two image forming apparatuses executes the image formation from the next page of the first page to the trailing page in a descending order of pages with a group output to output sets of the designated number for each page.

In this regard, in the present invention, an allocation manner to determine an assigned amount assigned to the one of the two image forming apparatuses and an assigned amount assigned to the other one of the two image forming apparatuses is not specifically limited, the assigned amounts may be determined equally or an allocation ratio may be determined with a consideration of output capacity among the image forming apparatuses.

Further, the control section may be provided to either of the image forming apparatuses, or the two image forming apparatuses may perform its function cooperatively. Further, it may be provided to an external device such as a terminal connected to the above image forming apparatuses, or the external device and the image forming apparatuses may perform its function cooperatively. The control section may be structured with a CPU and a program to work the CPU.

The image forming system described in Item 2 is characterized in that in the image forming system described in Item 1, the control section controls the two image forming apparatuses such that the one of the two image forming apparatuses makes an ejection direction of a recording medium to be face-down and the other one of the two image forming apparatuses makes an ejection direction of a recording medium to be face-up.

According to the image forming system described in Item 2, the ejection direction can be set reversely face-down and face-up among the image forming apparatuses assigned the job. Here, The face-down means that when a recording medium subjected to an image formation is ejected to an sheet ejection tray, the recording medium is conveyed while placing an image formation-conducted surface downward, and when an image formation was conducted on both sides of a recording medium, the recording medium is conveyed while placing a previous image formation-conducted surface downward. On the other hand, the face-up means that when a recording medium subjected to an image formation is ejected to an sheet ejection tray, the recording medium is conveyed while placing an image formation-conducted surface upward, and when an image formation was conducted on both sides of a recording medium, the recording medium is conveyed while placing a previous image formation-conducted surface upward. For both of the face-down and the face-up, while the sheet ejection is conducted successively, usually, recording media are stacked sequentially on the top side.

With the above, by setting the sheet ejection direction reversely the face-down and the face-up among the image forming apparatuses assigned the job execution, recording media outputted in the ascending order from the leading page and recording media outputted in the descending order from the trailing page can be set easily by jointing sheets.

The image forming system described in Item 3 is characterized in that in the image forming system described in Item 1 or 2, the predetermined page range is the initial page to the final page.

According to the image forming system described in Item 3, the tandem group output can be conducted by allocating the entire pages of the image formation job among the two image forming apparatuses.

The image forming system described in Item 4 is characterized in that in the image forming system described in any one Items 1 to 3, there is provided an allocation recovering section to change the allocation such that in the tandem mode, all or a part of un-outputted pages of allocated pages allocated to the one of the image forming apparatuses are outputted by the other one of the image forming apparatuses.

At the time of the tandem group output, when one of the image forming apparatuses has completed its output on ahead, the allocation is changed such that all or a part of un-outputted pages of allocated pages of the other one of the image forming apparatuses can be outputted by the one of the image forming apparatuses having completed its output, whereby the image forming apparatus having completed its output can output (allocation recovery) the changed allocation. In the allocation recovery, since a part of the allocation being outputted in the ascending order is taken over by the side outputting in the descending order, or a part of the allocation being outputted in the descending order is taken over by the side outputting in the ascending order, it becomes the situation in which only a allocation position is changed, the change of the allocation can be conducted easily, and it becomes the situation in which the output order is put in order. Incidentally, although the group output in the tandem output can be conducted in tree or more image forming apparatuses, among at least two image forming apparatuses, outputs are conducted in the ascending order at the leading page side and in the descending order at the trailing page side by allocating a range from the leading page to the first page and a range from the next page of the first page to the trailing page in the predetermined page range, whereby the allocation recovery in which the output order is put in order between the two image forming apparatuses can be possible.

The allocation recovering section is a section to function depending on a progress status of a processing in each image forming apparatus, for example, may be a section to work by one function of the control section. Incidentally, with regard to the progress status of the processing, the progress status of each image processing apparatus can be get by informing from each image forming apparatus or by inquiring to each image forming apparatus. As a case that the allocation recovering section functions, a case that an image forming apparatus has completed its output earlier than other image forming apparatus, a case that an image forming apparatus stops works due to lack of paper or jamming, or a case that a processing needs many times due to waiting for output of other reserved image formation jobs, may be listed. Namely, in the present invention, the situation that the allocation recovering section functions is not limited to a specific situation, it can function in the case that the processing times among image forming apparatuses are in disproportion.

The image forming system described in Item 5 is characterized in that in the image forming system described in Item 4, the allocation recovering section changes the allocation such that a part or all at a trailing page side in outputting order in un-outputted pages of allocated pages of one of image forming apparatuses are outputted by the other one of image forming apparatuses, and the other one of image forming apparatuses outputs the un-outputted pages of the changed allocation in reverse order from the trailing page in the outputting order after outputting the allocated pages.

According to the image forming system described in Item 5, at the time of the allocation recovery, since an ascending order output from the leading page and a descending order from the trailing page are executed among the image forming apparatuses with the outputting order adjusted by changing an allocation position, an erroneous mix-up or confusion in the outputting order due to the allocation recovery does not occur.

In the allocation recovery, for example, in the case that handover is conducted from an image forming apparatus which is outputting with the ascending order, pages from the second page to the trailing page in the un-outputted pages are handed over to the other one of image forming apparatuses and are outputted from the trailing page with the descending order. Further, in the case that handover is conducted from an image forming apparatus which is outputting with the descending order, pages from the third page to the leading page in the un-outputted pages are handed over to the other one of image forming apparatuses and are outputted from the leading page with the ascending order.

The image forming system described in Item 6 is characterized in that in the image forming system described in Item 4, the allocation recovering section changes the allocation such that a par or all of un-outputted pages of allocated pages changes in the other one of image forming apparatuses are outputted by one of image forming apparatuses.

An image forming apparatus described in Item 7 is an image forming apparatus which is provided with an image forming section to form an image on an image recording medium based on image data and a communicating section to connect with other image forming apparatus so as to be able to communicate and can execute a tandem mode to conduct an image formation with regard to a single image formation job by sharing it with the other image forming apparatus, and the image forming apparatus is characterized by comprising:

an instruction inputting section to input an instruction to set executing the tandem mode; and

a control section to control the image forming section and to output an instruction to the other image forming apparatus through the communicating section such that when an instruction to set executing the tandem mode by is inputted by the instruction inputting section, an execution of an image formation from a leading page to a first page in a predetermined page range of the single image formation job is assigned to one of the image forming apparatus and the other image forming apparatus and an execution of an image formation from a next page of the first page to a trailing page in the predetermined page range is assigned to the other one of the image forming apparatus and the other image forming apparatus, the one of the image forming apparatus and the other image forming apparatus executes the image formation from the leading page to the first page in an ascending order of pages with a group output to output a designated number of sets for each page and the other one of the image forming apparatus and the other image forming apparatus executes the image formation from the next page of the first page to the trailing page in a descending order of pages with a group output to output sets of the designated number for each page.

According to the image forming apparatus described in Item 7, in the image forming apparatus, pages from a leading page to a first page in a predetermined page range of the single image formation job can be outputted in ascending order with a group output or pages from a next page of the first page to a trailing page in the predetermined page can be outputted in descending order of pages with a group output. At this time, in the one of the image forming apparatus and the other image forming apparatus, if pages from the leading page to the first page in a predetermined page range of the single image formation job are outputted in ascending order with a group output, in the one of the image forming apparatus and the other image forming apparatus, pages from the next page of the first page to the trailing page in the predetermined page are outputted in descending order of pages with a group output. The control section is installed in the image forming apparatus, for example, the control section can be structured with CPU and a program to work it.

Incidentally, the image forming apparatus is connected with the other image forming apparatus through the communicating section, and the communicating section makes it possible to conduct transmitting and receiving in a single direction or a bi-direction between the image forming apparatus and the other image forming apparatus or with the other external apparatus. Usually, each apparatus is connected through a network such as LAN, and so on, and each apparatus is provided with a LAN interface to connect to the network as the communicating section. Further, the image forming apparatus may be connected with a direct cable.

In the tandem mode, image forming apparatuses conduct image formation interlockingly based on image data read by one of image forming apparatuses or image data inputted from the outside. The tandem mode may work always or may work in response to an operation with a tandem mode selecting button. Further, an image forming apparatus shifts in the tandem mode upon receipt of a tandem mode setting notice from the other image forming apparatus. The tandem mode can be conducted by the control section.

Further, the group output mode outputs recording media subjected to image formation by predetermined number sets for each page in ascending order or descending order of pages, and the group mode output can be conducted by the control section.

The image forming apparatus described in Item 8 is characterized in that in the image forming apparatus described in Item 7, the control section assigns an execution of an image formation from a leading page to a first page in a predetermined page range of the image formation job to one of the two image forming apparatuses and assigns an execution of an image formation from a next page of the first page to a trailing page in the predetermined page range to the other one of the two image forming apparatuses.

According to the image forming apparatus described in Item 8, an allocation of pages from a leading page to a first page and pages of from a next page of the first page to a trailing page in the tandem mode can be conducted by the control section. The present apparatus executes a group output in accordance with the allocation and the other apparatus executes a group output upon receipt of the result of the allocation.

The image forming apparatus described in Item 9 is characterized in that in the image forming apparatus described in Item 7 or 8, there is provided an allocation recovering section to change the allocation such that in the tandem mode, all or a part of un-outputted pages of allocated pages allocated to the one of the image forming apparatuses is outputted by the other one of the image forming apparatuses.

At the time of the tandem group output, when one of the image forming apparatuses has completed its output on ahead, the allocation is changed (allocation recovery) such that all or a part of un-outputted pages of allocated pages of the other one of the image forming apparatuses can be outputted by the one of the image forming apparatuses having completed its output. The allocation recovering section is a section to function depending on a progress status of a processing in each image forming apparatus, for example, may be a section to work by one function of the control section. The allocation recovering section may make handover of allocation from the one of the image forming apparatuses to the other one of the image forming apparatuses, or reversely from the other one of the image forming apparatuses to the one of the image forming apparatuses. It may be desirable to select the direction of handover depending to outputting situation of the image forming apparatuses.

In the tandem group output, the ascending order output from a leading page in a predetermined page range or the descending order output from a trailing page in the predetermined page range can be controlled by the control section of the image forming apparatus. In this regard, a control to make the output order reverse to the other apparatus can be conducted by transmitting or receiving information of outputting order through the communicating section among the image forming apparatuses. Further, the allocation and the outputting order are set preliminarily among the image forming apparatuses, and at the time of the tandem group output, the output may be conducted based on the setting.

The image forming apparatus described in Item 10 is characterized in that in the image forming apparatus described in Item 9, at the time of the tandem group output, the allocation recovering section changes the allocation such that a part or all at a trailing page side in outputting order in un-outputted pages of allocated pages of one of image forming apparatuses are outputted by the other one of image forming apparatuses, and the other one of image forming apparatuses outputs the un-outputted pages of the changed allocation in reverse order from the trailing page in the outputting order after outputting pages allocated preliminarily.

According to the image forming apparatus described in Item 10, at the time of the allocation recovery, an erroneous mix-up or confusion in the outputting order due to the allocation recovery does not occur.

The image forming apparatus described in Item 11 is characterized in that in the image forming apparatus described in any one of Items 7 to 10, there is provided a tandem group output receiving section to receive the completion of a tandem group output by the other apparatus through the communicating section.

According to the image forming apparatus described in Item 11, by receiving a notice of output completion from the other apparatus having completed its tandem output, it become possible to judge whether an allocation recovery is necessary or not or to execute a change of allocation.

The image forming apparatus described in Item 12 is characterized in that in the image forming apparatus described in any one of Items 9 to 11, the allocation recovering section judges whether or not to change an allocation such that when one of the two image forming apparatuses has completed its tandem group output, a part or all of un-outputted pages of allocated pages of the other one of two image forming apparatuses are outputted by the one of image forming apparatuses.

According to the image forming apparatus described in Item 12, upon receipt of a notice that one of the image forming apparatuses has completed its tandem group output, the control section can judges based on a remaining amount of un-outputted pages of the other image forming apparatus and a comparison of respective outputting capacity of the two image forming apparatuses whether or not an allocation recovery is conducted, unnecessary recovery not contributing to an increase of output efficiency can be avoided.

The image forming apparatus described in Item 13 is characterized in that in the image forming apparatus described in any one of Items 9 to 12, when one of the two image forming apparatuses has completed its tandem group output, the allocation recovering section conducts a change of an allocation such that a part or all of un-outputted pages of allocated pages of the other one of two image forming apparatuses are outputted by the one of image forming apparatuses.

According to the image forming apparatus described in Item 13, upon receipt of a notice that one of the image forming apparatuses has completed its tandem group output, a change of an allocation can be conducted by the allocation recovering section. The change of an allocation is conducted such that a remaining amount of allocated pages is changed to the half of it for each apparatus, or respective remaining amounts becomes respective appropriate amounts in consideration of respective printing capacities of the image forming apparatuses.

Further, in the change of allocation, the change of allocation can be noticed to the other apparatus together with the changed amount. At this time, in the case that the other apparatus has image data including image data for recovery by sending preliminary all data corresponding to the tandem output, only the notice may be conducted. However, in the case that the other apparatus has only image data for initially allocated pages, it become necessary to send together with the notice image data necessary for the other apparatus due to the change of allocation. The above notice and the image data can be sent through the communicating section.

The image forming apparatus described in Item 14 is characterized in that in the image forming apparatus described in any one of Items 7 to 13, there is provided a paper ejection order selection inputting section to select the paper ejection order of the present apparatus.

According to the image forming apparatus described in Item 14, at the time of the tandem group output, it becomes possible to select a paper ejection order in ascending order from the leading page in a predetermined page range or in descending order from the trailing page in a predetermined page range in the present apparatus by the paper ejection order selection inputting section. That is, by the selection of the ascending order or the descending order, an output from the leading page or an output from the trailing page can be determined. As the paper ejection order selection inputting section, an input device such as a touch panel provided on the image forming apparatus can be used.

The image forming apparatus described in Item 15 is characterized in that in the image forming apparatus described in Item 14, the control section determines a paper ejection order of the other apparatus based on the paper ejection order of the present apparatus.

According to the image forming apparatus described in Item 15, by selecting a paper ejection order in ascending order from the leading page in a predetermined page range or in descending order from the trailing page in a predetermined page range in the present apparatus by the paper ejection order selection inputting section, a paper ejection order in ascending order from the leading page or in descending order from the trailing page in the other apparatus is automatically selected.

The image forming apparatus described in Item 16 is characterized in that in the image forming apparatus described in any one of Items 7 to 15, the control section notices the paper ejection order of the present apparatus or the other apparatus or the paper ejection order of the present apparatus and the other apparatus to the other apparatus through the communicating section.

According to the image forming apparatus described in Item 16, information of a paper ejection order of the present apparatus or the other apparatus or these is noticed to the other apparatus, and the paper ejection order in the other apparatus is set adequately.

The image forming apparatus described in Item 17 is characterized in that in the image forming apparatus described in any one of Items 7 to 16, when the paper ejection order of the other apparatus selected by the other apparatus is noticed through the communicating section, the control section sets the reverse order of the noticed paper ejection order as the paper ejection order of the present apparatus.

According to the image forming apparatus described in Item 17, when the paper ejection order of the other apparatus is noticed through the communicating section, the paper ejection order of the present apparatus can be set to the reverse order of the paper ejection order of the other apparatus by the control section. With this, a tandem group output capable of conducting an allocation recovery can be done adequately.

The image forming apparatus described in Item 18 is characterized in that in the image forming apparatus described in any one of Items 7 to 17, when the paper ejection order of the other apparatus selected by the other apparatus is noticed through the communicating section, the control section sets the paper ejection order of the present apparatus in accordance with the notice.

According to the image forming apparatus described in Item 18, upon receipt of the notice of the paper ejection order of the present apparatus determined by the other apparatus, the paper ejection order of the present apparatus can be set adequately by the control section.

The image forming apparatus described in Item 19 is characterized in that in the image forming apparatus described in any one of Items 7 to 18, there is provided a paper ejection direction switching section to switch the paper ejection direction to face-down or face-up.

According to the image forming apparatus described in Item 19, the paper ejection direction can be switched to face-down or face-up by the paper ejection direction switching section. The paper ejection direction switching section can be structured a conveyance switching guide provided on a recording medium conveyance passage, a reversing roller and so on.

The image forming apparatus described in Item 20 is characterized in that in the image forming apparatus described in Item 19, there is provided a paper ejection direction selection inputting section to select face-down or face-up as the paper ejection direction of the present apparatus.

According to the image forming apparatus described in Item 20, the paper ejection direction can be switched over face-down or face-up optionally by the paper ejection direction selection inputting section. As the paper ejection direction selection inputting section, an input device such as a touch panel may be used.

The image forming apparatus described in Item 21 is characterized in that in the image forming apparatus described in Item 19 or 20, the control section determines the paper ejection direction of the other apparatus to be face-up in the case that the paper ejection direction of the present apparatus is face-down or the paper ejection direction of the other apparatus to be face-down in the case that the paper ejection direction of the present apparatus is face-up.

According to the image forming apparatus described in Item 21, the paper ejection directions among the image forming apparatuses subjected to the allocation can set reversely face-down and face-up. With this, recording media outputted in the ascending order from the leading page and recording media outputted in the descending order from the trailing page can be set easily by jointing sheets.

The image forming apparatus described in Item 22 is characterized in that in the image forming apparatus described in any one of Items 19 to 21, the control section notices the paper ejection direction of the present apparatus or the other apparatus or the paper ejection direction of the present apparatus and the other apparatus to the other apparatus through the communicating section.

According to the image forming apparatus described in Item 22, information of the paper ejection direction of the present apparatus or the other apparatus or the paper ejection direction of the present apparatus and the other apparatus is noticed to the other apparatus by the control section, thereby the paper ejection direction of the other apparatus is set so as to make sheet setting easy.

The image forming apparatus described in Item 23 is characterized in that in the image forming apparatus described in any one of Items 19 to 22, when the paper ejection direction of the other apparatus selected by the other apparatus is noticed through the communicating section, the control section sets the reverse direction of the noticed paper ejection direction as the paper ejection direction of the present apparatus.

According to the image forming apparatus described in Item 23, when the paper ejection direction of the other apparatus is noticed through the communicating section, the paper ejection direction of the present apparatus can be set to the reverse direction of the paper ejection direction of the other apparatus by the control section. With this, a tandem group output is done to make sheet setting easy.

The image forming apparatus described in Item 24 is characterized in that in the image forming apparatus described in any one of Items 19 to 23, when the paper ejection direction of the other apparatus selected by the other apparatus is noticed through the communicating section, the control section sets the paper ejection direction of the present apparatus in accordance with the notice.

According to the image forming apparatus described in Item 24, upon receipt of the notice of the paper ejection direction of the present apparatus determined by the other apparatus, the paper ejection direction of the present apparatus can be set by the control section.

A control device of an image forming apparatus described in Item 25 is provided with:

an instruction inputting section to input an instruction to set a execution of a tandem mode to conduct an image formation with regard to a single image formation job by sharing it with plural image forming apparatus to form an image on an image recording medium based on image data; and

a tandem group output instructing section to instruct such that when an instruction to set executing the tandem mode by is inputted by the instruction inputting section, the tandem group output instructing section assigns an execution of an image formation from a leading page to a first page in a predetermined page range of the single image formation job to one of the two image forming apparatuses and assigns an execution of an image formation from a next page of the first page to a trailing page in the predetermined page range to the other one of the two image forming apparatuses, and the tandem group output instructing section instructs the one of the two image forming apparatuses to execute a group output to output image formations from the leading page to the first page in an ascending order of pages by a designated number of sets for each page and instructs the other one of the two image forming apparatuses to execute a group output to output image formations from the next page of the first page to the trailing page in a descending order of pages by sets of the designated number for each page.

According to the control device of the image forming apparatus described in Item 25, it becomes possible to output by the plural image forming apparatuses with the instruction to execute the tandem mode from the control device. In the two image forming apparatuses, with the instruction to execute the tandem group output from the control device, one of the two image forming apparatuses executes a group output to output image formations from the leading page to the first page in an ascending order of pages by a designated number of sets for each page, and the other one of the two image forming apparatuses executes a group output to output image formations from the next page of the first page to the trailing page in a descending order of pages by sets of the designated number for each page.

The control device of the image forming apparatus described in Item 26 is characterized in that in the control device of the image forming apparatus described in Item 25, the two image forming apparatuses are controlled such that the ejection direction of the recording medium from the one of the two image forming apparatuses is made face-down and the ejection direction of the recording medium from the other one of the two image forming apparatuses is made face-up.

According to the control device of the image forming apparatus described in Item 26, by making the paper ejection direction of the two image forming apparatuses face-down and face-up reverse to each other, recording media outputted from the leading page in the ascending order and recording media outputted from the trailing page in the descending order are easily set by sheet setting.

The control device of the image forming apparatus described in Item 27 is characterized in that in the control device of the image forming apparatus described in Item 25 or 26, there is provided an allocation recovering section to change the allocation such that in the tandem mode, all or a part of un-outputted pages of allocated pages allocated to the one of the image forming apparatuses is outputted by the other one of the image forming apparatuses.

With the allocation recovering section, at the time of the tandem group output, the allocation of each image forming apparatus can be changed depending on the progress status of the processing in each image forming apparatus.

As described above, according to the image forming system of the present invention, in an image forming system capable of executing a tandem mode to conduct an image formation with regard to a single image formation job by sharing it with plural image forming apparatus to form an image on an image recording medium based on image data, the image forming system comprises:

an instruction inputting section to input an instruction to set a execution of the tandem mode; and

a control section to control at least two image forming apparatuses such that when an instruction to set executing the tandem mode by is inputted by the instruction inputting section, the control section assigns an execution of an image formation from a leading page to a first page in a predetermined page range of the single image formation job to one of the two image forming apparatuses and assigns an execution of image formations from a next page of the first page to a trailing page in the predetermined page range to the other one of the two image forming apparatuses, the one of the two image forming apparatuses executes the image formation from the leading page to the first page in an ascending order of pages with a group output to output a designated number of sets for each page and the other one of the two image forming apparatuses executes the image formation from the next page of the first page to the trailing page in a descending order of pages with a group output to output sets of the designated number for each page. Accordingly, a group output can be conducted in the tandem mode, a working efficiency of the machine is increased, further, since recording media are outputted on a condition that outputting order is adjusted, the paper ejection order is not disordered, and after the image formation job has been completed, it may not necessary or each to replace page orders.

Further, in the tandem among apparatus types different in copying speed, or in the case that some differences in progress status among image forming apparatuses are caused by JAM or paper supply in the course of an image formation job, it is possible to conduct an allocation recovery to allocate allocated pages of each apparatus to the other apparatuses and even if the allocating action occurs in the course of an image formation job, pages are printed in order and it may be possible to omit labor hour for replacing pages in order after an image formation job has been completed.

Further, in addition to the paper ejection order, if face-down and face-up are reverse among image forming apparatuses, after an image formation job has been completed, an output document with the successive page order can be obtained easily by merely superimposing two sets of ejected recording media.

Further, according to the image forming apparatus, in an image forming apparatus which is provided with an image forming section to form an image on an image recording medium based on image data and a communicating section to connect with other image forming apparatus so as to be able to communicate and can execute a tandem mode to conduct an image formation with regard to a single image formation job by sharing it with the other image forming apparatus, the image forming apparatus is provided with:

an instruction inputting section to input an instruction to set executing the tandem mode; and

a control section to control the image forming section and to output an instruction to the other image forming apparatus through the communicating section such that when an instruction to set executing the tandem mode by is inputted by the instruction inputting section, an execution of an image formation from a leading page to a first page in a predetermined page range of the single image formation job is assigned to one of the image forming apparatus and the other image forming apparatus and an execution of an image formation from a next page of the first page to a trailing page in the predetermined page range is assigned to the other one of the image forming apparatus and the other image forming apparatus, the one of the image forming apparatus and the other image forming apparatus executes the image formation from the leading page to the first page in an ascending order of pages with a group output to output a designated number of sets for each page and the other one of the image forming apparatus and the other image forming apparatus executes the image formation from the next page of the first page to the trailing page in a descending order of pages with a group output to output sets of the designated number for each page. Accordingly the two image forming apparatuses can cooperatively conduct group output in the tandem mode, and effects similar to the above can be obtained.

Further, according to a control device of an image forming apparatus, the control device of an image forming apparatus is provided with:

an instruction inputting section to input an instruction to set a execution of a tandem mode to conduct an image formation with regard to a single image formation job by sharing it with plural image forming apparatus to form an image on an image recording medium based on image data; and

a tandem group output instructing section to instruct such that when an instruction to set executing the tandem mode by is inputted by the instruction inputting section, the tandem group output instructing section assigns an execution of an image formation from a leading page to a first page in a predetermined page range of the single image formation job to one of the two image forming apparatuses and assigns an execution of an image formation from a next page of the first page to a trailing page in the predetermined page range to the other one of the two image forming apparatuses, and the tandem group output instructing section instructs the one of the two image forming apparatuses to execute a group output to output image formations from the leading page to the first page in an ascending order of pages by a designated number of sets for each page and instructs the other one of the two image forming apparatuses to execute a group output to output image formations from the next page of the first page to the trailing page in a descending order of pages by sets of the designated number for each page. Accordingly, the two image forming apparatuses can cooperatively conduct group output in the tandem mode, and effects similar to the above can be obtained.

### Embodiment 1

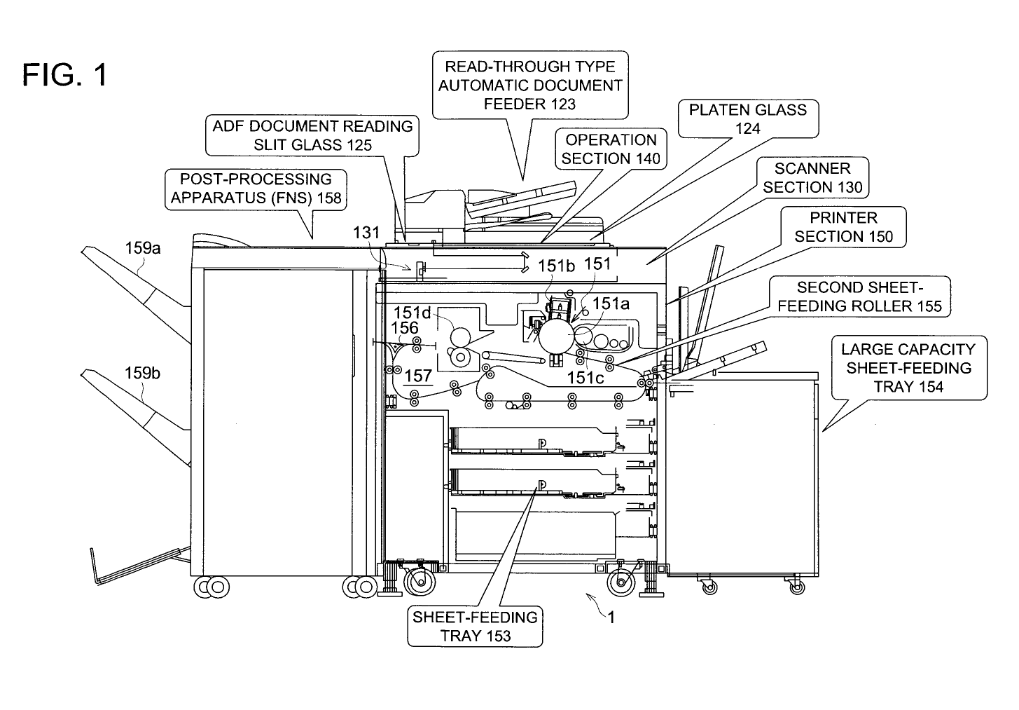

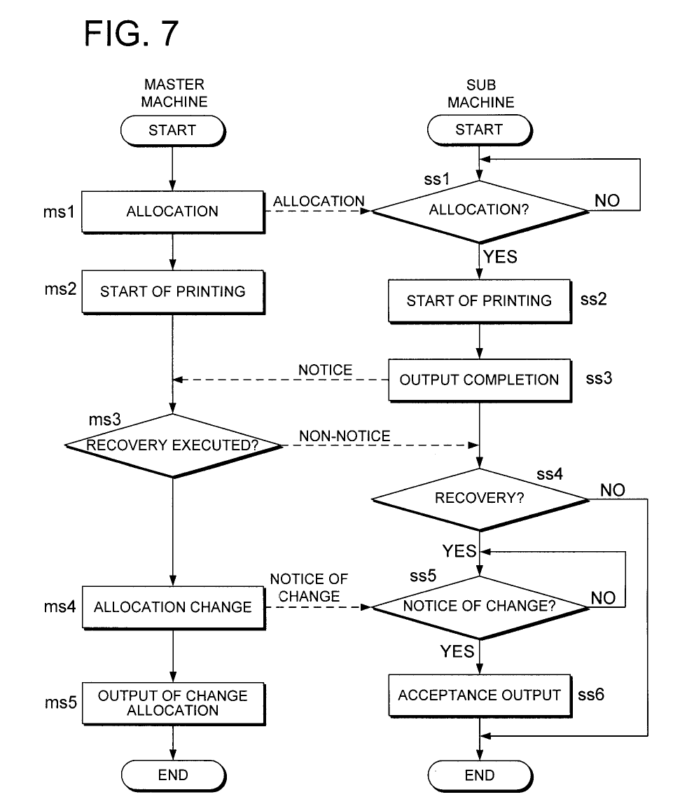

An embodiment of the invention will be explained as follows, referring to FIG. 1-FIG. 7.

FIG. 1 shows a mechanical structure of image forming apparatus 1 of the invention, and the mechanical structure will be explained as follows.

The image forming apparatus 1 is provided on its upper portion, with scanner section 130 including CCD 131, automatic document feeder (ADF) 123, platen glass 124 on which a document is set, ADF document reading slit glass 125, which constitute a document reading means. Further, on the portion where platen glass 124 is not located on the upper portion of the image forming apparatus 1, there is provided operation section 140 which makes it possible for an operator to operate.

The scanner section 130 is provided under the platen glass 124 and the ADF document reading slit glass 125, and CCD 131 of the scanner section 130 obtains document data by making light irradiated on the document surface and reflected thereon to form an image.

Sheet-feeding tray 153 is arranged in the lower portion of the image forming apparatus 1, and further, large capacity sheet-feeding tray 154 which is to be a sheet-feeding tray equally is arranged in a way to be attached to the image forming apparatus 1. Second sheet-feeding roller 155 is arranged at a destination for the sheet from these sheet trays. An image forming section composed of LD 151 and others is provided at the position that is downstream side of the second sheet-feeding roller 155 in the conveyance direction. The image forming section is composed of photoconductor 151a, charging unit 151b, developing unit 151c and fixing unit 151d. Printer section 150 is composed of the aforesaid image forming section, sheet-feeding tray 153, large capacity sheet-feeding tray 154 and second sheet-feeding roller 155. Further, conveyance switching guide 156 that switches the conveyance direction is arranged on the conveyance path that is on the downstream side of the image forming section, and turnaround rollers group 157 is arranged to the lower side of the conveyance switching guide 156. The conveyance switching guide 156 and the turnaround rollers group 157 are controlled by image control CPU 113, then, a recording medium sent from the upperstream side is moved to the turnaround rollers group 157 side through the guide by the conveyance switching guide 156, and the recording medium is conveyed reversely to be guided by the conveyance switching guide 156 to the sheet ejection side, thus, the recording medium can be reversed inside out. When the recording medium is not reversed by the conveyance switching guide 156 and the turnaround rollers group 157, the recording medium is moved to the downstream side as it is with its surface facing upward, while, when the recording medium is reversed, the recording medium is moved to the downstream side with its surface facing downward. Therefore, the conveyance switching guide 156 and the turnaround rollers group 157 function as a sheet-ejection direction switching means. Incidentally, image forming on reverse side of the recording medium can be carried out by conveying the recording medium to the second sheet-feeding roller 155 side by switching the conveyance direction to the turnaround rollers group 157 with the conveyance switching guide 156.

Further, post-processing apparatus (FNS) 158 is arranged at the downstream side of the conveyance switching guide 156, so that required post-processing (stapling, punching and others) can be carried out for the recording medium on which an image has been made. Main sheet-ejection tray 159a and sub-sheet-ejection tray 159b are provided at the downstream side of the post-processing apparatus 158.

The aforesaid image forming apparatus is composed of a digital multifunctional machine, and another image forming apparatus 2 is connected by LAN 50 that constitutes a network to be capable of tandem outputting, to form a tandem image forming system. Though image forming apparatuses 1 and 2 are shown in the drawing as an image forming apparatus, the number of the image forming apparatuses is not limited in the invention. Incidentally, external devices 30 such as a terminal and an external processing device may also be connected to the LAN 50. The external devices 30 is equipped with operation means 35 and display means 36. In the meantime, the image forming apparatus 2 has also the same mechanical structure as in the image forming apparatus 1, and its explanation will be omitted here accordingly.

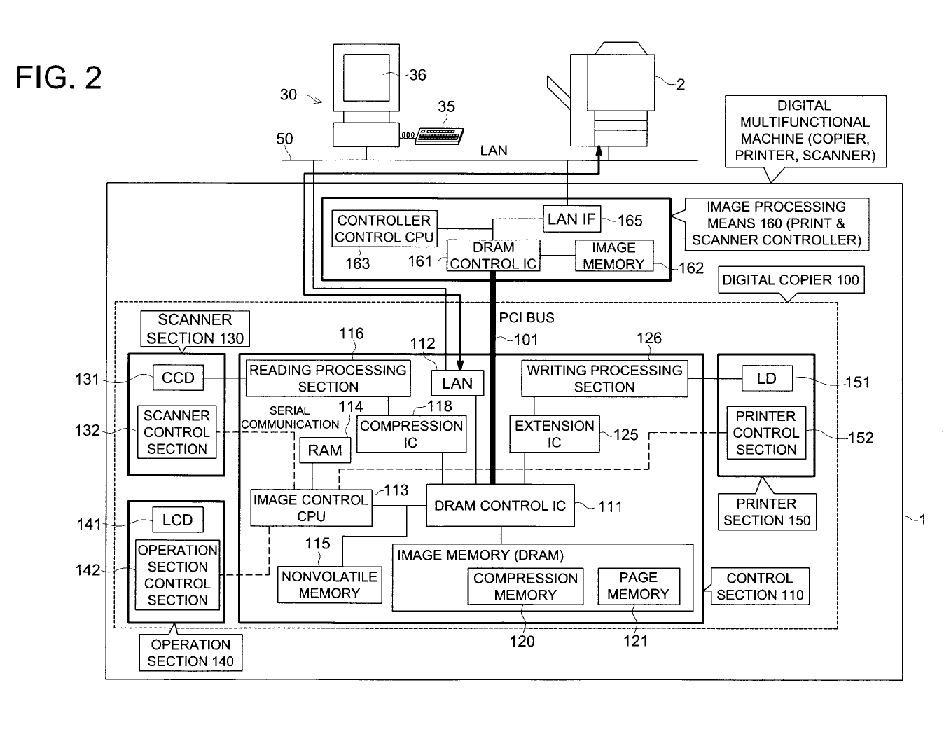

FIG. 2 shows image forming apparatus 1 as a functional block diagram, and its contents will be explained in detail as follows.

Namely, the image forming apparatus 1 is equipped with digital copier 100 having control section 110, scanner section 130, operation section 140 and printer section 150 and with image processing means 160 that conducts processing of image data inputted and outputted between itself and the outside through LAN 50.

Control section 110 of the digital copier 100 has LAN interface 112 connected to LAN 50 as stated above, as a communication means, and the LAN interface 112 is connected to DRAM control IC 111 of the control section 110, inside the image forming apparatus 1. Further, the control section 110 is equipped with image control CPU 113 that controls the whole of the image forming apparatus, and the DRAM control IC 111 is connected to the image control CPU 113.

Further, RAM 114 and nonvolatile memory 115 are connected to the image control CPU 113. The RAM 114 is utilized as a working area and as a memory for temporary storage of established information. In the nonvolatile memory 115, there are stored data of initial setting information such as a program for operating the image control CPU 113, various established data of the image forming apparatus 1 and process control parameter. The image control CPU 113 can read and write data stored in RAM 114 and nonvolatile memory 115.

Further, the image control CPU 113 can communicate with other image forming apparatuses through LAN 50 (for machine=IP address designated in advance) via the aforesaid LAN interface 112, and it can conduct transmitting and receiving of image data and established parameter between itself and other image forming apparatuses. Owing to this, the LAN interface 112 can function as a communication means of the invention.

In the case of output for printing of plural number of copies, the image control CPU 113 can give instructions for printing, depending on a sort sheet ejection mode for outputting in the ascending order or the descending order along each page and a group outputting mode for outputting in the ascending order or the descending order of pages for prescribed number of copies for each page.

Further, in the case of outputting image information, the image control CPU 113 can assign the output to plural image forming apparatuses, and can give instructions for tandem output to each image forming apparatus. Namely, the tandem mode functions, following the operations of the image control CPU 113. Then, in the image control CPU 113, setting (address in the network and output setting) for each image forming apparatus that is connected under the tandem mode is created.

Incidentally, when conducting group output in a tandem mode (hereinafter referred to as tandem group output), the group output is assumed to be conducted through the outputting method in the ascending order from the forefront page or the outputting method in the descending order from the last page, in the image control CPU 113. When the output in the ascending order from the forefront page is conducted by another image forming apparatus, the self image forming apparatus is to conduct the output in the descending order from the last page, while when the output in the descending order from the last page is conducted by another image forming apparatus, the self image forming apparatus is to conduct the output in the ascending order from the last page. Namely, the image control CPU 113 functions as a control means in the invention.

In addition, the image control CPU 113 has an allocation recovery function that changes the aforesaid allocation depending on the state of progress for output in each image forming apparatus in the case of tandem output. Therefore, the image control CPU 113 and the program operating the image control CPU 113 function as an allocation recovery means. In the case of allocation recovery, it is possible to judge with the image control CPU 113 whether to conduct allocation recovery in accordance with the state of progress or not, and when the allocation recovery is decided to be conducted, a change in an allocated amount to the other image forming apparatus and transfer of image data are conducted. In the meantime, in the image control CPU 113, when conducting allocation recovery in the case of tandem group output, an instruction for output is established to be given so that a part or the whole of the rest of an allocation to the other apparatus is transferred, and output is conducted from the last portion of the transferred allocation in the reverse order.

In the image control CPU 113, when the output of the self apparatus is completed in the case of tandem group output, completion of the output is notified to other image forming apparatuses through the aforesaid LAN interface 112. Further, in the image control CPU 113, completion of the output of the other apparatus in the case of tandem group output is received through the aforesaid LAN interface 112. Therefore, the image control CPU 113 functions as a notifying means for tandem group output completion and a receiving means for tandem group output completion.

The aforesaid scanner section 130 is equipped with CCD 131 that conducts optical reading and with scanner control section 132 that controls the scanner section 130. The scanner control section 132 is connected to the image control CPU 113 to be capable of conducting serial communication, and is controlled by the image control CPU 113. The CCD 131 is connected to reading and processing section 116 that processes image data acquired through reading by the CCD 131, and the reading and processing section 116 is connected with compression IC 118 that compresses image data, which is connected to the aforesaid DRAM control IC 111.

The DRAM control IC 111 is connected to image memory (DRAM) composed of compression memory 120 and page memory 121. Further, extension IC 125 that extends compressed image data is connected to the DRAM control IC 111, and writing processing section 126 is connected to the extension IC 125. The writing processing section 126 is connected to LD (laser diode) 151 of printer section 150, to conduct processing of data used for operations of the LD 151. Further, the printer section 150 is equipped with printer control section 152 that controls the whole of the printer section 150, and the printer control section 152 is connected to the image control CPU 113 to be controlled. An image forming means of the invention is composed of the aforesaid printer section 150 and writing and processing section 126.

Further, DRAM control IC 161 of image processing means 160 is connected to the DRAM control IC 111 through PCI bus 191. In the image processing means 160, the DRAM control IC 161, controller control CPU 163 and LAN interface 165 are connected to the common bus. The LAN interface 165 is connected to the LAN 50.

The operation section 140 stated above is equipped with LCD touch panel 141 representing an input section and with operation section control section 142 which is connected to the LCD touch panel 141, and the operation section control section 142 is connected to the image control CPU 113 to be controlled. In the operation section 140, various setting in image forming apparatus 1 and instructions for operations can be inputted, and contents of setting and various types of information can be displayed, and further operations for moving to the tandem mode can be made. Accordingly, the operation section 140 corresponds to an instruction inputting means for practicing a tandem mode. Further, on the operation section 140, selection between sort sheet ejection mode and group output mode, selection of sheet ejection order (ascending order or descending order) and selection of sheet ejection direction (face-up or face-down) are allowed. Therefore, the operation section 140 has a function as a sheet ejection order selection input means or a sheet ejection direction selection input means.

Meanwhile, in the image control CPU 113, when the aforesaid sheet ejection order is established in the case of tandem group output, it is possible to decide the sheet ejection order of the other apparatus to be opposite to the aforesaid sheet ejection order. The aforesaid sheet ejection order can be notified to other image forming apparatuses through the LAN interface 112. The sheet ejection order to be notified may either be only one for other apparatuses, or be one for other apparatuses plus one for the self apparatus. Therefore, the image control CPU 113 functions as a means to decide sheet ejection order for other apparatus and a means to notify sheet ejection order. In the image forming apparatus which has received a notice of decision of sheet ejection order from other apparatuses, the image control CPU 113 provided in the image forming apparatus can establish the sheet ejection order of the self apparatus. Therefore, the image control CPU 113 functions as a means to set sheet ejection order of self apparatus.

Incidentally, in the image control CPU 113, it is also possible to notify the sheet ejection order of the self apparatus to other apparatuses, without deciding the sheet ejection order of the other apparatuses. In the image control CPU 113 on the other apparatus side, it is possible to set the sheet ejection order of the self apparatus after receiving this notice. Accordingly, the image control CPU 113 functions as a means to set sheet ejection order for self apparatus even in this case.

Again, in the image control CPU 113, when the aforesaid sheet ejection direction is established in the case of tandem group output, it is possible to decide the sheet ejection direction of the other apparatus to be opposite to the aforesaid sheet ejection direction. The aforesaid sheet ejection direction can be notified to other image forming apparatuses through the LAN interface 112. The sheet ejection direction to be notified may either be only one for other apparatuses, or be one for other apparatuses plus one for the self apparatus. Therefore, the image control CPU 113 functions as a means to decide sheet ejection direction for other apparatus or a means to notify sheet ejection direction. In the image forming apparatus which has received a notice of decision of sheet ejection direction from other apparatuses, the image control CPU 113 provided in the image forming apparatus can establish the sheet ejection direction of the self apparatus. Therefore, the image control CPU 113 functions as a means to set sheet ejection direction of self apparatus.

Incidentally, in the image control CPU 113, it is also possible to notify the sheet ejection direction of the self apparatus to other apparatuses, without deciding the sheet ejection direction of the other apparatuses. In the image control CPU 113 on the other apparatus side, it is possible to set the sheet ejection direction of the self apparatus after receiving this notice. Accordingly, the image control CPU 113 functions as a means to set sheet ejection direction for self apparatus even in this case. From the foregoing, the image control CPU 113 functions as a means to instruct tandem group output.

Incidentally, image forming apparatus 2 also has the same functional structures as in the image forming apparatus 1, which was not explained above. Thus, the explanation of them will be omitted here.

Next, basic operations of the aforesaid image forming apparatus will be explained.

First, procedures to acquire image data in the image forming apparatus 1 will be explained. While, the image forming apparatuses 1 and 2 have the same structure as stated above, and their basic actions are the same each other. Therefore, the explanation will be given as follows by using the structure of the image forming apparatuses 1.

First, an explanation will be given for the occasion wherein image data are generated by reading images with scanner section 130 in the image forming apparatus 1.

In the scanner section 130, images are read optically from the document by CCD 131. When the document is placed with its surface to be read facing downward on platen glass 124, an optical system scans along the platen glass 124 to read. Further, when the document is fed automatically by automatic document feeder 123, reading is conducted under the condition that the optical system is fixed for ADF document reading slit glass 125. In this case, operations of CCD 131 are controlled by scanner control section 132 that receives instructions from image control CPU 113. The image control CPU 113 is operated by the program and issues instructions for scanner section 130 based on operations by operation section 140 and on instructions of external apparatuses.

Images read by CCD 131 are subjected to prescribed image data processing in reading and processing section 116, image data thus data-processed are compressed in compression IC 118, and are stored in compression memory 120 through DRAM control IC 111.

Further, image data can also be acquired from the outside, and the data in that case are received by image processing means 160 of the image forming apparatus 1 through LAN 50—LAN interface 165, and are stored in image memory 162 by DRAM control IC 161. Data of the aforesaid image memory 162 are stored in page memory 121 through DRAM control IC 161, PCI bus 101 and DRAM control IC 111. Data of page memory 121 are sent to compression IC 118 in succession through DRAM control IC 111 to be subjected to compression processing, and are stored in compression memory 120 through DRAM control IC 111. This acquisition of image data is conducted when the image forming apparatus 1 is used as a printer from the outside.

Further, as another example, image data are generated through image reading in the image forming apparatus 2, for example, and are transmitted through LAN 50. These data are received through LAN interface 112, and are stored in the aforesaid compression memory 120 by DRAM control IC 111. In the case of the tandem mode, the image data sent from other image forming apparatuses are received by the aforesaid procedures.

Further, image data stored in the compression memory 120 can be transmitted to other image forming apparatus 2 and others through DRAM control IC 111, LAN interface 112 and LAN 50. In other image forming apparatus 2 and others, the aforesaid image data can be received and accumulated, and further can be subjected to image forming processing. In the case of the tandem mode, the image data are transmitted to other image forming apparatuses by the aforesaid procedures.

When the image forming apparatus 1 is used as a scanner, image data stored in compression memory 120 from scanner section 130 by the aforesaid procedures are sent to extension IC 125 through DRAM control IC 111 to be extended, and then, are stored temporarily in page memory 121 through DRAM control IC 111. Data in the page memory 121 are stored in image memory 162 of image processing means 160 through DRAM control IC 111 and PCI bus 101. Image data stored in the image memory 162 are sent to external device 30 through LAN 50 via DRAM control IC 161 and LAN interface 165 in case of need.

Next, an occasion to conduct image output with image forming apparatus 1 will be explained.

When image forming apparatus 1 is used as a copier or as a printer, image data are sent to extension IC 125 through DRAM control IC 111 to be extended after the image data are developed to page memory 121 from compression memory 120, after the image data are stored in compression memory 120 in the aforesaid way, then, the extended data are sent to writing and processing section 126 and writing on a photoconductor is carried out in LD 151. Further, in printer section 150, printer control section 152 receives instructions of image control CPU 113 to control respective portions. Owing to the foregoing, printing on the prescribed recording medium (not shown) is carried out in the printer section 150, and post-processing is conducted in post-processing apparatus 160 through the control of post-processing control CPU 161 as occasion demands. In the meantime, for this output, output is made by sort sheet ejection or by group output in the case of plural number of copies, and sheets are ejected to main sheet-ejection tray 159a or sub sheet-ejection tray 159b through face-up mode or face-down mode for sheet ejection.

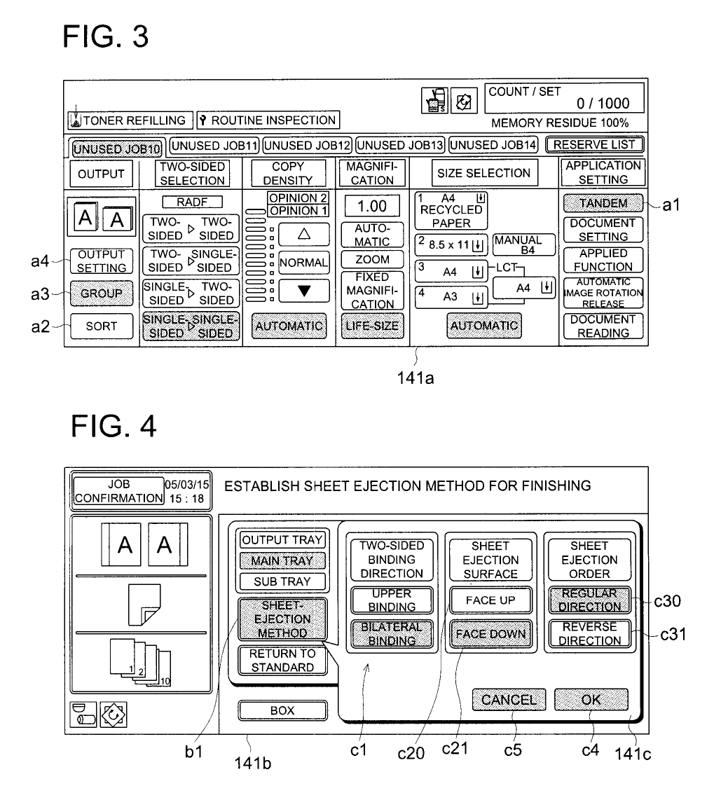

Movement to tandem group output employing image forming apparatus 1 having the aforesaid structure and selection of a sheet-ejection method will be explained as follows, referring to FIG. 3 and FIG. 4. Incidentally, in this embodiment, a self apparatus is assumed to be a master apparatus, and another apparatus is assumed to be a sub-apparatus in the explanation.

FIG. 3 is one showing main operation screen 141a in operation section 140, which has therein tandem button a1 for moving to a tandem mode, sort mode button a2 that selects sort sheet-ejection mode and group mode button a3 for selecting group output mode, and it further has output setting button a4 for setting an outputting method. When the tandem mode button a1 is pressed, the tandem mode is selected, and this mode is notified to image forming apparatus 2, and the tandem mode is established between both image forming apparatuses. Therefore, the aforesaid output setting button a4 functions as an instruction inputting means that inputs an instruction to establish practice of the tandem mode. Further, if the group mode button a3 is pressed after moving to the tandem mode, the group output mode in the tandem bode is established. When the sort mode button a2 is pressed, a sort sheet-ejection mode in the tandem mode is established.

When the output setting button a4 is pressed, output setting screen 141b is displayed on operation section 140 to be able to input operations as shown in FIG. 4, in place of main operation screen 141a.

In the output setting screen 141b, there is provided sheet-ejection method button b1, and when it is pressed, sheet-ejection method selecting screen 141c is window-displayed. In the sheet-ejection method selecting screen 141c, there are provided binding position selection button group c1, sheet-ejection direction selection buttons c20 and c21 and sheet-ejection order selection buttons c30 and c31, and further, OK button c4 and cancel button c5 are provided.

When the sheet-ejection direction selection button c20 is pressed, the face-up is selected as a sheet-ejection direction of the self apparatus, while, when the sheet-ejection direction selection button c21 is pressed, the face-down is selected as a sheet-ejection direction of the self apparatus. Further, when the sheet-ejection order selection button c30 is pressed, the ascending order is selected as a sheet-ejection order of the self apparatus, while, when the sheet-ejection direction selection button c31 is pressed, the descending order is selected as a sheet-ejection order of the self apparatus.

While, when the tandem group output is in the state to be selected, if the sheet-ejection order of the self apparatus is the ascending order, the allocation becomes to be on the side of the page on the forefront, while, if the sheet-ejection order of the self apparatus is the descending order, the allocation becomes to be on the side of the rearmost page.

After each selection mentioned above is made, if OK button c4 is pressed, the contents of the selection is established, and the contents of setting is stored temporarily in the aforesaid RAM 114 by returning to main operation screen 141a. Further, if cancel button c5 is pressed on output setting screen 141, the contents of the selection are canceled to be returned to the contents of initial setting. When a selection change is not made on the output setting screen 141, information of initial setting concerning a sheet-ejection direction and a sheet-ejection order stored in nonvolatile memory 115 is used.

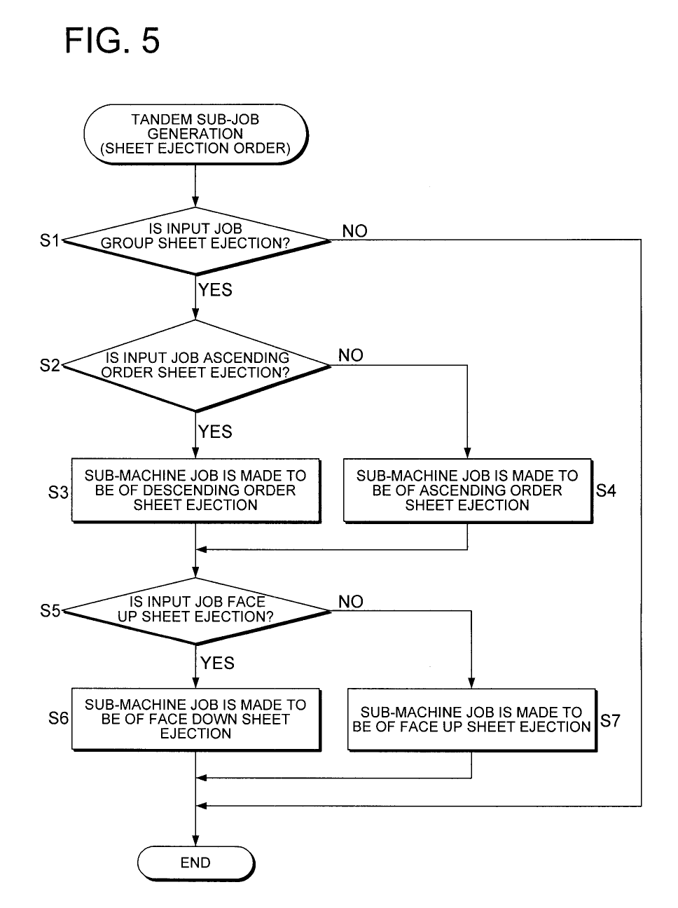

When operations are started through operations of a push button such as a copy-start button (not shown) based on the tandem mode, on the output setting screen 141, if image data have not been obtained, document reading is carried out, and tandem-sub JOB generating routine is further started as shown in FIG. 5.

In the aforesaid routine, it is determined first whether input JOB is one by the group output mode or not (step s1). This determination is made by image control CPU 113. If the input JOB is not one by the group output mode as a result of the determination, the processing of this routine is terminated, and tandem output by an ordinary sort mode is carried out. On the other hand, when the group output mode is selected, it is determined whether the ascending order is selected or not as an output order concerning the input JOB. When the ascending order is selected, the output order of the sub-apparatus is decided to be a descending order (step s3), while, when the ascending order is not selected, namely, the descending order is selected, the output order of the sub-apparatus is decided to be an ascending order (step s4). After the steps s3 and s4, it is determined whether the face-up is selected or not as an output direction concerning the input JOB. When the face-up is selected as a sheet-ejection direction of the self apparatus, a sheet-ejection direction of the sub-apparatus is decided to be face-down (step s6), while, when the face-down is selected as a sheet-ejection direction of the self apparatus, a sheet-ejection direction of the sub-apparatus is decided to be face-up (step s7). Information about sheet-ejection order and sheet-ejection direction of the other apparatus decided by this routine is stored temporarily in RAM 114.

Based on the aforesaid setting, image data which have been acquired are allocated. The allocation may be made either by dividing equally in accordance with the number of image forming apparatuses or by dividing proportionally by considering a difference in printing capability between image forming apparatuses. In this allocation, the forefront page side is allocated by the image forming apparatus on which the sheet-ejection order is set to the ascending order, and the rearmost page side is allocated by the image forming apparatus on which the sheet-ejection order is set to the descending order.

Following the aforesaid allocation, the master apparatus transmits all image data to the sub-apparatus side through LAN interface 112 and LAN 50 together with header data including contents of output setting. Incidentally, image data may also be those from which a partial image data corresponding to the allocated portion (allocated pages) only are transmitted, without being those which are transmitted totally. However, it is preferable to transmit all image data in advance, if the allocation recovery which will be explained later is considered.

As a content to be set, those including the following data, for example, can be given.

Binding position Upper binding/Right and left binding

Sheet-ejection surface Face-up/Face-down

Sheet-ejection order Regular direction/Reverse direction

Sheet-ejection mode Sort/Group

Staple None/1 location/2 locations

Punch None/2 holes/3 holes

Output tray Master/Sub

Allocation −( ) pages/+( ) pages

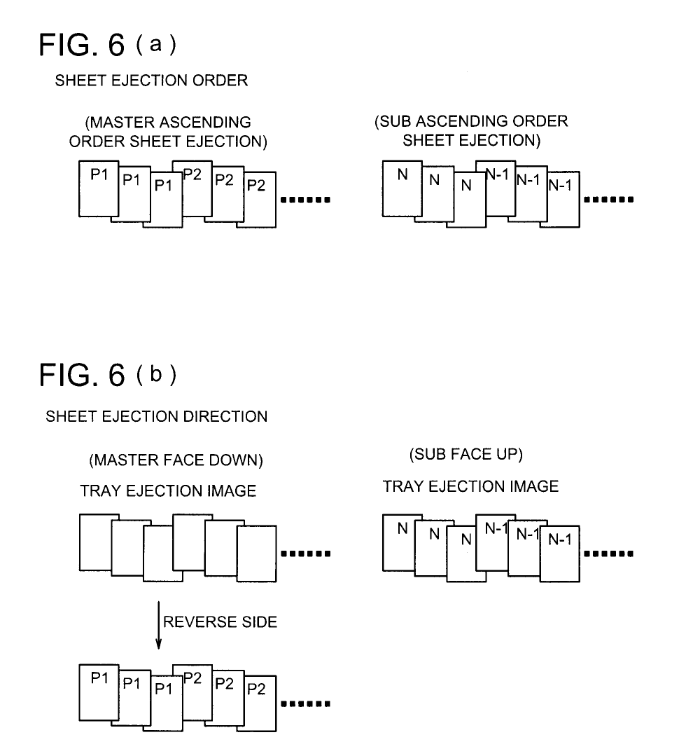

Based on the aforesaid allocation, ascending order output (1 to N) from the forefront page is carried out on the image forming apparatus on one side, and descending order output (N to 1) from the rearmost page is carried out on the image forming apparatus on the other side, as shown in FIG. 6 (a), in the master apparatus and the sub-apparatus. Though the ascending order sheet-ejection is on the master side and the descending order sheet-ejection is on the sub side in the drawing, it is also possible to arrange, contrary to the foregoing, so that the descending order sheet ejection (N to 1) is on the master side and the ascending order sheet ejection (1 to N) is on the sub side.

In this case, in the master apparatus and the sub apparatus, recording media outputted from both image forming apparatuses through tandem group output can be aligned easily by outputting through face-down from image forming apparatus on one side and through face-up from image forming apparatus on the other side, as shown in FIG. 6 (b).

Incidentally, though the occasion to adjust both the sheet-ejection order and the sheet-ejection direction was explained in the aforesaid embodiment, the invention may also include the occasion where the sheet-ejection order only is adjusted.

Next, a procedure to conduct allocation recovery with tandem group output will be explained. Meanwhile, the explanation will be given under the assumption that output is completed by the sub apparatus first in this procedure.

In the tandem group output by the master apparatus and the sub apparatus, allocation on the master apparatus side is conducted, and established data and image data are transmitted to the sub apparatus based on the allocation (step ms1). On the sub apparatus side, the flow moves to the next step after waiting the allocation (step ss1). After the aforesaid step ms1 and step ss1, tandem group output is conducted based on the allocation on the master apparatus and the sub apparatus (step ms2, ss2). In the case of this output, when the output is completed by the sub apparatus earlier, a notice of this output completion is transmitted to the master apparatus side. The notice of this output completion is notified by image control CPU 113 on the sub apparatus side to the master apparatus side through LAN interface 112 and LAN 50. On the master apparatus side, image control CPU 113 receives output completion on the sub apparatus from LAN interface 112 on the master apparatus side through LAN 50. On the sub apparatus side, an instruction for existence of recovery practice from the master apparatus side is waited after giving a completion notice (step ss4). The master apparatus receives the completion notice of the sub apparatus, and determines whether to conduct allocation recovery for changing the allocation by considering residual quantity of output (step ms3). Incidentally, in this case, the master apparatus determines that recovery practice is not needed, when the printing is already terminated, or un-outputted residual quantity is not sufficient. When the practice is not needed, the result of the determination is notified to the sub apparatus by image control CPU 113 on the master apparatus side, through LAN interface 112 and LAN 50. On the sub apparatus side, this notice is received, and output processing is terminated.

On the other hand, when the determination is made to conduct allocation recovery on the master apparatus side, image control CPU 113 on the master apparatus side establishes an amount to be transferred allocated to the sub-apparatus side based on the un-outputted residual quantity among the allocated portion on the master apparatus side (step ms4). This amount to be transferred can be determined by dividing equally or by dividing proportionally by considering outputting capability of the master apparatus and that of the sub-apparatus, in the same way as in the initial allocation. Incidentally, this portion to be transferred is selected from the rearmost page side in the output order of the aforesaid un-outputted residual portion (un-outputted pages). When the output is conducted in the ascending order on the master apparatus, the portion to be transferred covers from the page that precedes the aforesaid first page by prescribed pages to the first page among the un-outputted portion. On the other hand, when the output is conducted in the descending order on the master apparatus, the portion to be transferred covers from the page next to the aforesaid first to the page succeeding to the aforesaid page by prescribed pages. After the allocation is changed on the master apparatus, a notice of the change is given to the sub-apparatus. In that case, if image data for all pages have already been held on the sub-apparatus side, the contents of the change only are notified. If image data of the initial allocation share only are held on the sub-apparatus side, image data corresponding to the changed portion of the allocation are transmitted together with the contents of the change to the sub-apparatus from the master apparatus. After the allocation is changed, the master apparatus continues outputting for the changed allocation that is acquired by deducting an amount transferred to the sub-apparatus (step ms5), and processing is terminated based on completion of the output. In the meantime, the allocation recovery can also be conducted two times or more without being limited to one time, and when the output is completed first on the master apparatus side, the master apparatus can undertake a part of the allocated portion for the sub-apparatus side and can output on the master apparatus side in the same way. On the sub-apparatus side, on the other hand, a notice of a change in the allocation is waited (step ss5), and output for the portion transferred by the notice is started in the order that is opposite to that of the master apparatus (step ss6). Namely, when the sub-apparatus has been outputting in the descending order, the aforesaid first page and thereafter among the aforesaid un-outputted portion are outputted in the descending order, and when the sub-apparatus has been outputting in the ascending order, a page next to the aforesaid first page and thereafter among the aforesaid un-outputted portion are outputted in the ascending order.

Owing to this, the continuity to the portion for which the output has been terminated first can be maintained. For the face-up and the face-down, it is desirable that the state before the recovery is maintained. The processing is terminated based on the completion of the output on the sub-apparatus side. It is possible to conduct the allocation recovery without any problem even in the tandem group output, and the recording medium thus outputted can maintain excellent continuity to those before the recovery.

### Embodiment 2

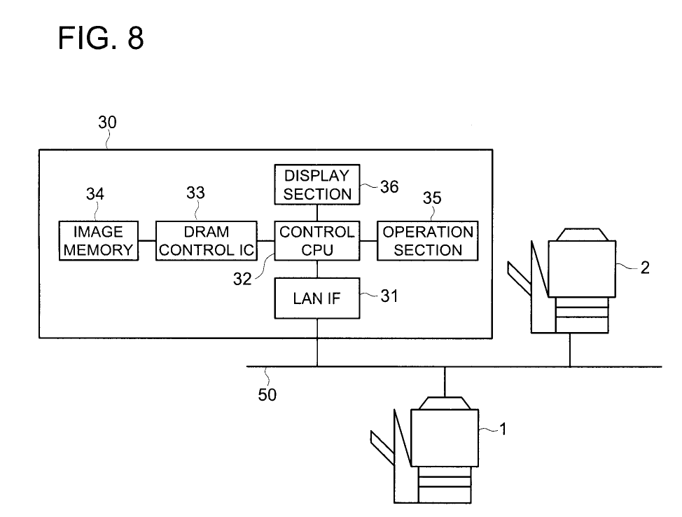

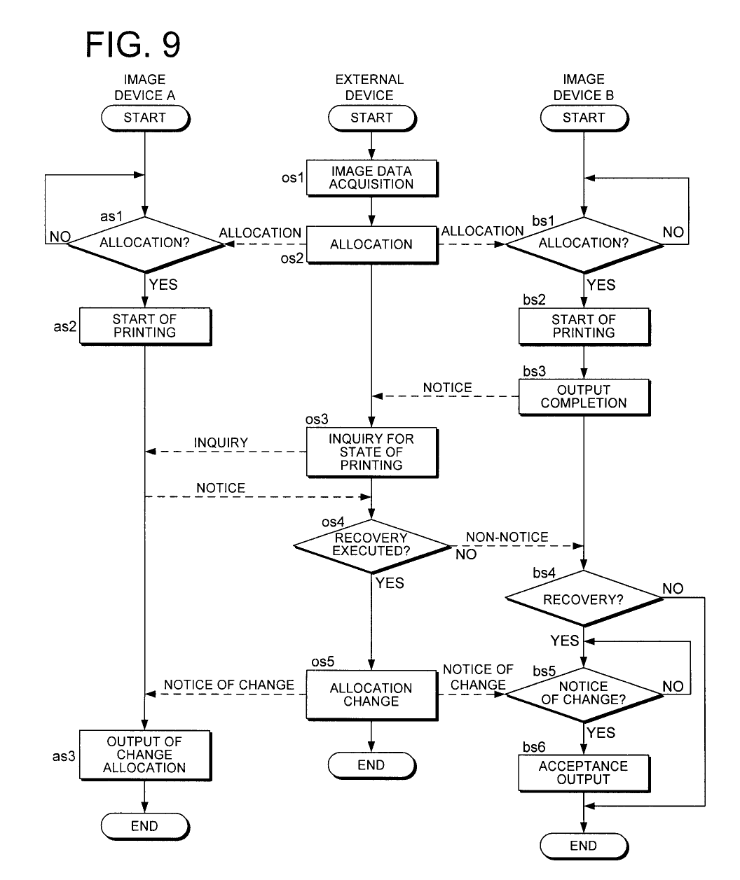

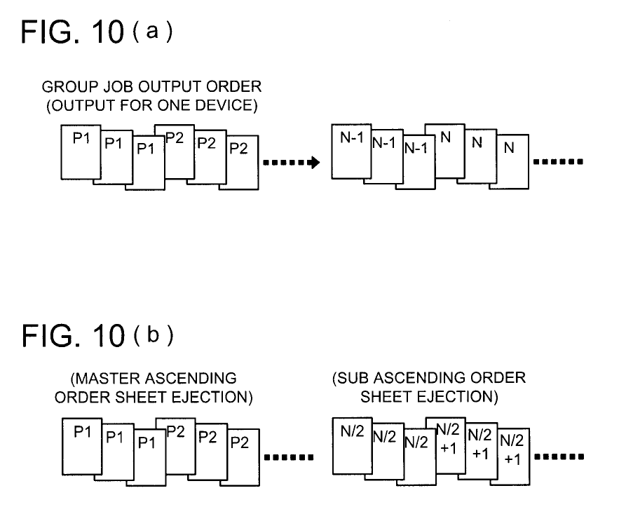

Further, in the aforesaid embodiment, there have been explained those wherein an image forming job is allocated by a control means equipped on an image forming apparatus to conduct tandem group output in the case of tandem output. However, in the invention, a control device provided outside the image forming apparatus can also control the allocation in the case of the tandem output and tandem group output. This embodiment will be explained as follows based on FIGS. 8 and 9. Since the basic structure of each of the image forming apparatuses 1 and 2 is the same as that in the aforesaid embodiment 1, an explanation of the structure will be omitted here.

In the present embodiment 2, external device 30 is connected to LAN 50 to which image forming apparatuses 1 and 2 are connected. The external device 30 is connected to the LAN 50 through LAN interface 31 representing a communication means, as shown in FIG. 8, and it is connected to control CPU 32 that controls the whole of the external device 30 to the LAN interface 31. To the CPU 32, there is connected DRAM control IC 33 which is connected to image memory 34 in which image data are stored. Further, to the control CPU 32, there are connected operation section 35 composed of a key board and others, and display section 36 composed of LCD and CRT, and these operation section 35 and display section 36 are controlled by the control CPU 33.

In the control CPU 32, instructions for practice of tandem mode for image forming apparatuses 1 and 2 are made to be possible, and the instructions for the practice are transmitted to a control means of each image forming apparatus through LAN interface 31 and LAN 50. In the control CPU 32, operations of instruction input through operation section 35 are made to be possible in the case of instructions for practice of the tandem mode. Therefore, the operation section 35 and the control CPU 32 function as a tandem mode instruction input means.

In the case of a tandem mode, the control CPU 32 can assign the practice of image forming for a range from the forefront page to the first page within the prescribed page range among an image forming job to an image forming apparatus on one side, and can assign the practice of image forming for a range from the page next to the aforesaid first page to the last page of the aforesaid prescribed page range to an image forming apparatus on the other side, for two image forming apparatuses 1 and 2. Further, in the case of this assignment, the control CPU 32 can give instructions to the image forming apparatus on one side to practice group output wherein the image forming apparatus on one side outputs each prescribed number of copies for each page in the ascending order of pages for image forming, and can give instructions to the image forming apparatus on the other side to practice group output wherein the image forming apparatus on the other side outputs each prescribed number of copies for each page in the descending order of pages for image forming. Therefore, the control CPU 32 functions as a tandem group output instructing mean. Thus, the external device 30 having the aforesaid structure functions as an external control device in the invention.

Next, control procedures to conduct tandem group output with image forming apparatuses 1 and 2 through control of the external device 30 will be explained as follows, referring to FIG. 9. In FIG. 9, the two image forming apparatuses are indicated as image forming apparatus A and image forming apparatus B, and in the following explanation, image forming apparatus A and image forming apparatus B are used for the explanation.

In the external device 30, image data representing outputs are acquired through practice of application program (step os1). The image data may also be those which are acquired as image data as scanner in the image forming apparatus and transmitted to the external device 30.

In the external device 30, image forming for a range from the forefront page to the first page in a prescribed page range among an image forming job and image forming for a range from the page next to the first page to the last page in the prescribed page range are allocated to two image forming apparatuses (step os2), based on the tandem mode practice instruction input through operation section 35. In the case of allocation, setting is carried out so that image forming for a range from the forefront page to the first page may be outputted in the ascending order of pages in the same way as in the embodiment 1 and setting is carried out so that image forming for a range from the page next to the first page to the last page in the prescribed page range may be outputted in the descending order of pages. Data thus set are transmitted to image forming apparatuses A and B together with the aforesaid image data. Even in this case, the whole data are transmitted respectively to image forming apparatus A and image forming apparatus B, with respect to image data. Incidentally, those wherein image data only in the allocated portion are transmitted to each image forming apparatus may also be accepted. Further, when image data are provided in an image forming apparatus, the aforesaid established data only are transmitted to each image forming apparatus. In each of the image forming apparatuses A and B, printing by tandem group output is started after receiving a notice of the allocation (steps as1, as2, bs1 and bs2).

When tandem group output is completed on either one of image forming apparatuses A and B, a notice of the completion is given to external device 30. In the present embodiment, output is completed first on image forming apparatus B, and its notice is given to the external device 30 (step bs3). The external device 30 which has received the notice of completion, makes inquires at image forming apparatus A about the state of printing (step os3). The image forming apparatus A which has received the inquiries notifies un-outputted residual quantity out of allocated portion to external devices. On the external device 30 which has received this notice, a decision is given on whether allocation recovery should be conducted or not, based on the residual quantity and others (step os4), and when a decision is given to conduct no recovery, this is notified to image forming apparatus B. On the image forming apparatus B which has received a notice to conduct no recovery, processing is terminated because allocation recovery is not needed (step bs4). On the other hand, when it is decided to practice allocation recovery on the external device 30, an allocation change is made. Namely, a part of un-outputted portion for image forming apparatus A is not outputted from the image forming apparatus A, but it is transferred to image forming apparatus B to be outputted from the image forming apparatus B (step bs5). The allocation change is notified to each of image forming apparatuses A and B. In the image forming apparatus A, output for the residual quantity excluding a portion to be transferred is conducted (step as3). On the other hand, on the image forming apparatus B, output for the transferred portion is conducted (step bs6) after waiting the notice of the change (step bs5). Incidentally, in the allocation change mentioned above, a range from the last page in the output order for an un-outputted portion in the allocated portion of the image forming apparatus to the page preceding the prescribed page in the outputting order is made to be a transferred portion, and in the image forming apparatus B, output is conducted in the inverse order, starting from the last page in the outputting order for the transferred portion. Owing to this, the tandem group output is conducted in a form where the initial allocation is changed.

Incidentally, in the aforesaid embodiment, there has been given an explanation of the pattern wherein an acquisition of image data at the external device 30, an instruction for practice of the tandem mode, allocation and an instruction for the tandem group output are conducted, and each of image forming apparatuses A and B is used as a printer. However, an acquisition of image data may also be conducted on either one of the image forming apparatuses, and image data may also be transferred between the image forming apparatuses. It is further possible to conduct allocation recovery between the image forming apparatuses, in addition to conducting on the external devices 30.

Though the present invention has been explained based on the aforesaid embodiments, the invention is not limited to the contents of the aforesaid explanation, and the disclosed embodiments can be varied properly without departing from the spirit and scope of the invention.

What is claimed is:

1. An image forming system in which plural image forming apparatuses to form an image on a recording medium based on image data are connected to be able to communicate, comprising:
a setting inputting section to set a tandem mode to execute a single image formation job by sharing the job among plural image forming apparatuses; and
a control section to control first and second image forming apparatuses such that when the tandem mode is set by the setting inputting section, the control section assigns an image formation from a leading page to a first page in a predetermined page range of the single image formation job to the first image forming apparatus and assigns an image formation from a next page of the first page to a trailing page in the predetermined page range to the second image forming apparatus, and the first image forming apparatus executes the image formation from the leading page to the first page in an ascending order of pages with a group output to output a designated number of sets for each page and the second image forming apparatus executes the image formation from the next page of the first page to the trailing page in a descending order of pages with a group output to output a designated number of sets for each page.

2. The image forming system described in claim 1, wherein the control section controls the first and second image forming apparatuses such that the one of the first and second image forming apparatuses makes an ejection direction of a recording medium to be face-down and the other one of the first and second image forming apparatuses makes an ejection direction of a recording medium to be face-up.

3. The image forming system described in claim 1, wherein the predetermined page range is from the initial page to the final page in the image formation job.

4. The image forming system described in claim 1, wherein the control section conducts an allocation recovery control such that in the tandem mode, a part or all of un-outputted-pages of the allocated-pages allocated to the first image forming apparatus are outputted by the second image forming apparatus in accordance with an outputting situation of the first and second image forming apparatuses.

5. The image forming system described in claim 4, wherein in the allocation recovery control, the second image forming apparatus outputs the un-outputted-pages of the changed allocated-pages in the descending order of pages after outputting pages allocated preliminarily.

6. The image forming system described in claim 4, wherein the allocation recovery control changes the allocated-pages such that a part or all of un-outputted-pages of allocated-pages changed to allocate to the second image forming apparatus are outputted by the first image forming apparatus.

7. An image forming apparatus, comprising:
an image forming section to form an image on an image recording medium based on image data;
a communicating section to connect to be able to communicate with other image forming apparatus;
a setting inputting section to set a tandem mode to execute a single image formation job by sharing the job with the other image forming apparatus; and
a control section to control the image forming section and to output an instruction to the other image forming apparatus through the communicating section such that when the tandem mode is set by the setting inputting section, the control section assigns an image formation from a leading page to a first page in a predetermined page range of the single image formation job to one of the image forming apparatus and the other image forming apparatus and assigns an image formation from a next page of the first page to a trailing page in the predetermined page range to the other one of the image forming apparatus and the other image forming apparatus, the one of the image forming apparatus and the other image forming apparatus executes the image formation from the leading page to the first page in an ascending order of pages with a group output to output a designated number of sets for each page and the other one of the image forming apparatus and the other image forming apparatus executes the image formation from the next page of the first page to the trailing page in a descending order of pages with a group output to output sets of the designated number for each page.

8. The image forming apparatus of claim 7, wherein the control section conducts a allocation recovery control such that in the tandem mode, a part or all of un-outputted-pages of the allocated-pages allocated to the one of the image forming apparatus and the other image forming apparatus are outputted by the other one of the image forming apparatus and the other image forming apparatus in accordance with an outputting situation of the image forming apparatus and the other image forming apparatus.

9. The image forming apparatus of claim 8, wherein the allocation recovery control changes the allocated pages such that a part or all at a trailing page side in the outputting order in the un-outputted-pages of pages allocated to one of the image forming apparatus and the other image forming apparatus are outputted by the other one of the image forming apparatus and the other image forming apparatus, and the other one of the image forming apparatus and the other image forming apparatus outputs the un-outputted-pages of the changed allocated-pages in a descending order of pages after outputting pages allocated preliminarily.

10. The image forming apparatus of claim 8, wherein the control section judges based on a predetermined condition whether or not the allocation recovery control is to be conducted.

11. The image forming apparatus of claim 7, wherein the communicating section receives from the other image forming apparatus a notice that the other image forming apparatus has completed outputting the allocated-pages.

12. The image forming apparatus of claim 7, further comprising:
a paper ejection order selection inputting section to select to eject a paper in an ascending order or in a descending order.

13. The image forming apparatus of claim 12, wherein the control section determines the paper ejection order of the other image forming apparatus so as to reverse to the paper ejection order of the image forming apparatus based on the selection by the paper ejection order selection inputting section.

14. The image forming apparatus of claim 12, wherein the control section notices the paper ejection order of at least one of the image forming apparatus and the other image forming apparatus to the other image forming apparatus through the communicating section.

15. The image forming apparatus of claim 12, wherein when the control section received the paper ejection order of the other image forming apparatus selected by the other image forming apparatus through the communicating section, the control section sets the paper ejection order of the image forming apparatus to be reverse to that of the other image forming apparatus.

16. The image forming apparatus of claim 7, further comprising:
a paper ejection direction switching section to switches the paper ejection direction to face-down or face-up.

17. The image forming apparatus of claim 16, further comprising:
a paper ejection direction selection inputting section to select face-down or face-up as the paper ejection direction, wherein the control section determines the paper ejection direction of the other image forming apparatus to be face-up when the paper ejection direction of the image forming apparatus is face-down, and the control section determines the paper ejection direction of the other image forming apparatus to be face-down when the paper ejection direction of the image forming apparatus is face-up.

18. The image forming apparatus of claim 17, wherein the control section notices the paper ejection direction of at least one of the image forming apparatus and the other image forming apparatus to the other image forming apparatus through the communicating section.

19. The image forming apparatus of claim 16, wherein when the control section receives the paper ejection direction of the other image forming apparatus selected by the other image forming apparatus through the communicating section, the control section sets the paper ejection direction of the image forming apparatus to be reverse to that of the other image forming apparatus.

20. A control device, comprising;
a setting inputting section to set a tandem mode to execute a single image formation job by sharing the job among plural image forming apparatuses to form an image on a recording medium based on image data; and
a control section to control first and second image forming apparatuses among the plural image forming apparatuses such that:
when the tandem mode is set by the setting inputting section, the control section assigns an image formation from a leading page to a first page in a predetermined page range of the single image formation job to the first image forming apparatus and assigns an image formation from a next page of the first page to a trailing page in the predetermined page range to the second image forming apparatus, and
the control section instructs based on the assignment such that the first image forming apparatus executes the image formation from the leading page to the first page in an ascending order of pages with a group output to output a designated number of sets for each page and the second image forming apparatus executes the image formation from the next page of the first page to the trailing page in a descending order of pages with a group output to output a designated number of sets for each page.

21. The control device of claim 20, wherein the control section controls the first and second image forming apparatuses such that the firs image forming apparatus makes an ejection direction of a recording medium to be face-down and the second image forming apparatus makes an ejection direction of a recording medium to be face-up.

22. The control device of claim 20, wherein the control section conducts an allocation recovery control to change allocated-pages so as to hand over a part or all of un-outputted-pages of the allocated-pages allocated to one of the first and second image forming apparatuses to the other one of the first and second image forming apparatuses and the control section makes the other one of the first and second image forming apparatuses to output the hand-over-pages.

23. An image forming system in which plural image forming apparatuses to form an image on a recording medium based on image data are connected to be able to communicate, comprising:
a setting inputting section to set a tandem mode to execute a single image formation job by sharing the job among plural image forming apparatuses and a group mode to conduct image formation for images of plural pages and to output a predetermines number of sets for each page; and
a control section to control first and second image forming apparatuses such that when the tandem mode and the group mode are set by the setting inputting section, the control section assigns an image formation from a leading page to a predetermined page a single image formation job to the first image forming apparatus and assigns an image formation from a next page of the predetermined page to a trailing page to the second image forming apparatus, and the first image forming apparatus executes the assigned image formation in an ascending order of pages and the second image forming apparatus executes the assigned image formation in a descending order of pages.
